(19) United States
(12) Patent Application Publication
(10) Pub. No.: US 2022/0327335 A1
(43) Pub. Date: Oct. 13, 2022

(54) CONTROLLING ASYNCHRONOUS FUSION OF SPATIO-TEMPORAL MULTIMODAL DATA

(71) Applicant: Microsoft Technology Licensing, LLC, Redmond, WA (US)

(72) Inventors: Kowshik THOPALLI, Tempe, AZ (US); Peeyush KUMAR, Seattle, WA (US); Ranveer CHANDRA, Kirkland, WA (US); Riyaz Mohamed PISHORI, Sammamish, WA (US)

(21) Appl. No.: 17/219,822

(22) Filed: Mar. 31, 2021

(51) Int. Cl. G06K 9/62; G06F 17/15

(52) U.S. Cl. CPC G06K 9/6288; G06F 17/156

(57) ABSTRACT

A system for fusion of multimodal receives a spatial input and a temporal input, wherein the spatial input comprises spatial data having spatial embeddings and the temporal input comprises temporal data having temporal embeddings. The spatial embeddings and the temporal embeddings have different time dimensions. A spatial data output with the spatial embeddings having a same time dimension as the temporal embeddings is generated from the spatial data based on a spatial perception model. The spatial perception model is pre-trained. A temporal data output is generated from the temporal data based on a temporal model. The spatial data output and the temporal data output are combined into an output representing dependencies between the spatial input and the temporal input using a fusion model. A desired target variable is obtained from the output and one of an estimated or predicted value is generated based on the desired target value.

### BACKGROUND

Critical data driven decision-making systems often use data from multiple input data modalities. Techniques exist to enable data fusion in these decision-making systems. These techniques typically consider, or make the assumption, that all the input modalities are obtained at the same temporal resolution (e.g., assume sampling frequencies of all modes of data available are the same, such that at any given point in time, samples from all modes are available). However, in many applications, such an assumption is practically not feasible and by design, input modalities have systematic temporal asynchronicity (e.g., sensor data and image data are acquired at different time intervals). Some systems use generative models, such as conditional random fields, which attempt to relax this assumption. However, even with relaxed assumptions, these systems have lower computational accuracies (e.g., for estimating or predicting output values) and provide less reliable and efficient decision making in critical data driven decision-making systems across different applications, particularly having inputs comprising spatio-temporal multimodal data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for fusion of multimodal data comprises receiving a spatial input and a temporal input, wherein the spatial input comprises spatial data having spatial embeddings and the temporal input comprises temporal data having temporal embeddings. The spatial embeddings and the temporal embeddings have different time dimensions. The computerized method further comprises generating, from the spatial data based on a spatial perception model, a spatial data output with the spatial embeddings having a same time dimension as the temporal embeddings. The spatial perception model being pre-trained with an autoencoder comprising a neural network. The computerized method also includes generating, from the temporal data based on a temporal model, a temporal data output, and combining, using a fusion model, the spatial data output and the temporal data output into an output representing dependencies between the spatial input and the temporal input. The computerized method additional comprises obtaining, from the output, a desired target variable, and generating, based on the desired target variable, one of an estimated or predicted value.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram illustrating a data processing system;

FIG. 2 is a block diagram of a multimodal data fusion system;

FIG. 3 is a block diagram of an autoencoder;

FIG. 4 is a block diagram of an asynchronous fusion architecture;

FIG. 5 is a block diagram illustrating fusion operations;

FIG. 6 is a soil temperature heatmap;

FIG. 7 is a block diagram of a fusion process;

FIG. 8 is a block diagram of a fusion mechanism;

FIG. 9 is a block diagram of a temporal decoder;

FIG. 10 is a block diagram of a spatial decoder;

FIG. 11 is a flow chart illustrating operations of a computing device for performing fusion of multimodal data;

FIG. 12 is a flow chart illustrating operations of a computing device for performing fusion of multimodal data to obtain a signal of interest; and

FIG. 13 illustrates a computing apparatus as a functional block diagram.

Corresponding reference characters indicate corresponding parts throughout the drawings. In the figures, the systems are illustrated as schematic drawings. The drawings may not be to scale.

### DETAILED DESCRIPTION

The computing devices and methods described herein are configured to control fusion of data, particularly asynchronous fusion of spatio-temporal multimodal data. An asynchronous fusion framework of various examples uses sparse correspondences between modalities (as compared to dense correspondences). In one example, asynchronous fusion uses pre-training of autoencoders (e.g., separately trained encoders) to derive pre-trained feature representations due to the lower complexity and lesser data requirements as compared to that of advanced models, such as transformers. A task-specific network is then trained with the feature representations from pre-trained networks fused with learned attention mechanisms, resulting in more reliable and accurate operation. Thus, the present disclosure overcomes at least the strong requirement of dense correspondences between data points from different modalities, while providing improved results.

The present disclosure allows for fusion of spatial data and temporal data, at least some of which is preprocessed before fusing. As a result of performing the operations described herein, machine learning is more efficiently and accurately performed using less data. In this manner, when a processor is programmed to perform the operations described herein, the processor is used in an unconventional way, and allows for the more efficient training or operation of a neural network, as well as resulting in more accurate results, such as more accurate deep learning based multimodal spatio-temporal fusion of data.

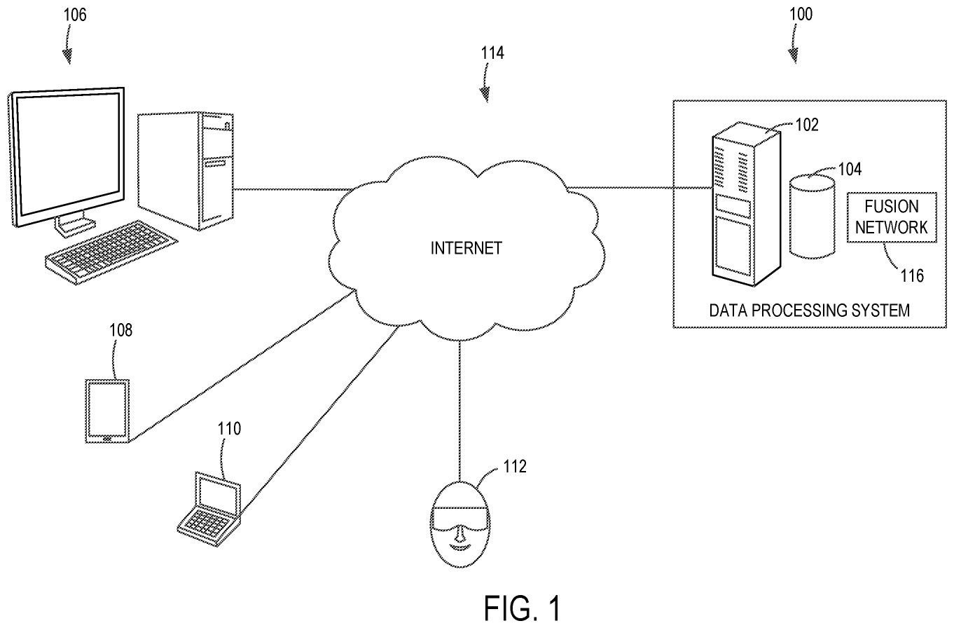

The data fusion processes described herein are not limited to fusing spatial data and temporal data, but can be implemented with different types of data for use in different applications. The data fusion processes, such as the asynchronous fusion of spatio-temporal multimodal data can be implemented in a data processing system 100 (e.g., a critical data driven decision-making system) deployed as a cloud service as illustrated in FIG. 1. In this example, the data processing system 100 implements the data fusion processes described herein to allow for efficient data fusion using sparse data (e.g., sparse measurement data). That is, the data processing system 100 operates using an asynchronous framework that in some examples relies only on sparse correspondence between data modalities.

The data processing system 100 includes one or more computers 102 and storage 104 to store, for example, multimodal data (e.g., spatial data, multivariate time series data, etc.). It should be appreciated that other data can be stored in the storage 104 and processed by the one or more computers 102 using the present disclosure.

The data processing system 100 is connected to one or more end user computing devices in some examples, such as a desktop computer 106, a smart phone 108, a laptop computer 110 and an augmented reality head worn computer 112 (e.g., Microsoft HoloLens®). For example, the data processing system 100 is shown as connected to the end user computing devices via a computer network 114, illustrated as the Internet.

The data processing system 100 receives input data, such as spatio-temporal multimodal data (e.g., sensor measurement data, image data, etc.) from an end user computing device or server. The data is uploaded to the data processing system 100 for processing, such as for data fusion processing that determines data dependencies for different data types, as well as over time. It should be appreciated that some or all of the data processing system 100 or the functionality of the data processing system 100 can be implemented within the end user computing device.

The data processing system 100 in this example implements a fusion network 116 that performs data fusion using less dense correspondence between data modalities (e.g., less dense measurement data), while producing accurate and reliable results (e.g., results for critical data decision-making processing). When the fusion network 116 is trained, deep learning based multimodal spatio-temporal fusion can be efficiently and accurately performed using less data (e.g. machine learning accurately performed with less data). In some examples, the functionality of the data processing system 100 described herein is performed, at least in part, by one or more hardware logic components. For example, and without limitation, illustrative types of hardware logic components that are used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Thus, with the present disclosure, reduced density of data and/or dependencies across data types can be used to efficiently and accurately fuse multimodal data. As such, computational accuracy can be maintained while having the reduced “cost” (e.g., computational and/or storage requirements) of the operations being performed using less data. For example, with the fusion network 116 of the present disclosure, machine learning is performed where otherwise not feasible, such as where input modalities have systematic temporal asynchronicity (e.g., for soil moisture or temperature heat mapping where sensor readings are obtained every fifteen minutes, but spatial data via satellite images are only obtained every two days).

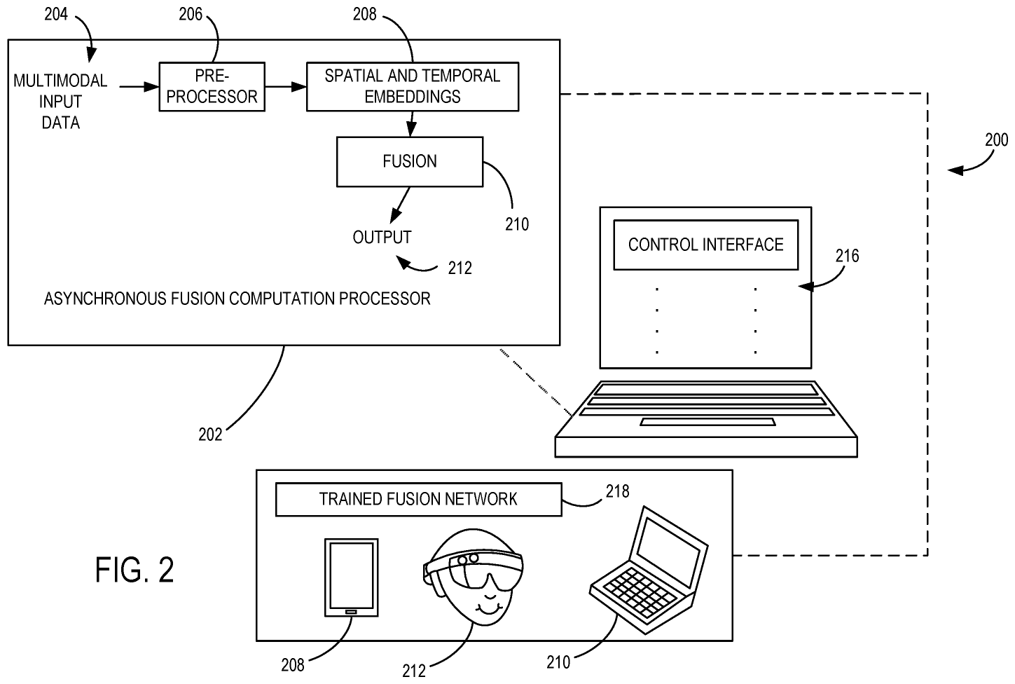

Various examples include a fusion network system 200 as illustrated in FIG. 2. The fusion network system 200 in one example uses pretraining in combination with different models to fuse asynchronous multimodal data as described herein to generate an output 212, which in one example is a target variable correlated with an input (in this example being multimodal input data 204). More particularly, the fusion network system 200 includes an asynchronous fusion computation processor 202 that is configured in some examples as a processing engine that performs data fusion of asynchronous multimodal data. It should be noted the present disclosure can be applied to different types of neural networks and machine learning implemented using multimodal data. In some examples, by pretraining encoders, and using various spatial, temporal, and fusion models, overall network accuracy can be maintained using less data and/or wherein all input modalities are not obtained at the same temporal resolution. It should be noted that the processes described herein can applied to various different neural network computations, different types of data, different applications. For example, the present disclosure can be implemented to perform asynchronous fusion for different geo-spatial tasks, such as: 1) estimating soil temperature at a different depth given soil temperature at one location, along with spatial data as captured via satellite, 2) generating heatmaps of climatic parameters of farms using sparse Internet of Things (IoT) sensor measurements in a farm along with multispectral images captured via satellite, and 3) estimating forest fire boundaries using weather data in conjunction with spatial digital elevation. In various examples, the present disclosure provides an accuracy above 95% in all applications.

The asynchronous fusion computation processor 202 has access to the input data 204, such as spatio-temporal multimodal data. For example, the asynchronous fusion computation processor 202 accesses sensor measurement and image data as the input data 204 for use in estimating or predicting different conditions, parameters, boundaries, etc. It should be appreciated that the asynchronous fusion computation processor 202 is configured to perform data fusion tasks in a wide variety of application domains such as environmental condition estimations or detection, speech recognition/enhancement, network optimization, scheduling, etc. However, the present disclosure provides multimodal learning for other different types of datasets, in addition to the spatio-temporal datasets described herein. For example, the asynchronous fusion computation processor 202 is configured to operate to process spatio-temporal datasets in agriculture, consumer applications, etc.

In one example, the present disclosure addresses agricultural spatio-temporal problems in the form of generating heatmaps of soil moisture, temperature, etc. from satellite images and sensors on a farm. The various examples facilitate forestry and disaster management relating to forest fires, such as to fuse data to allow for more accurate wildfire boundary maps predictions, As another example, spatio-temporal problems in oil and natural gas/energy industry can be addressed by facilitating detection of methane leaks using fused laser data and satellite images. In consumer applications, for example, the present disclosure can address spatio-temporal problems in audio visual speech recognition, enhancement, etc., wherein reasoning from audio and video frames are desired. In logistics and retail, the present disclosure can address spatio-temporal problems in network optimization, scheduling etc.

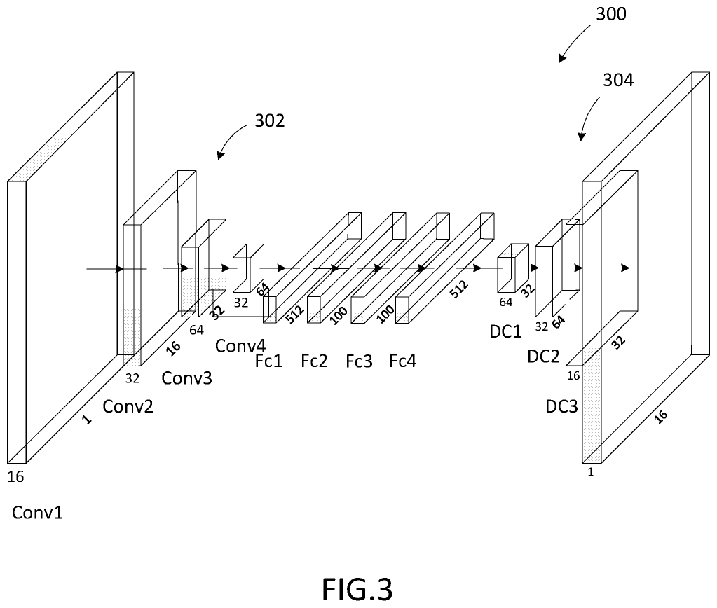

In the illustrated example, the input data 204 includes input modalities that are obtained at different temporal resolutions. The asynchronous fusion computation processor 202 first processes the input data 204 with a pre-processor 206 that is configured in some examples as a pre-trained autoencoder that preprocesses spatial data sets of the input data 204. One example of an autoencoder 300 is shown in FIG. 3, which is configured as a spatial (image) autoencoder. In this illustrated example, the autoencoder 300 is a combination of two networks 302 and 304, wherein the network 302 acts or operates as an encoder and the network 304 acts or operates as a decoder. The network 302 acting as the encoder, in one example, encodes each image into a lower dimensional latent space and the network 304 acting as the decoder attempts to reconstruct the image back to the original image space. In this configuration, the autoencoder 300 is configured to perform machine learning to learn (or identify) feature representations, which are referred to herein as embeddings. That is, the autoencoder 300 is configured having the networks 302 and 304 defining multiple neural network layers through which spatial data is passed for processing to obtain the dependencies, which includes dependencies across different types and over time.

It should be noted that for temporal datasets of the multimodal input data 204, some examples implement a one-dimensional convolutional neural network (CNN) to produce embeddings (temporal embeddings) having the same dimension (e.g., time scale) as the dimension of the spatial embeddings. The CNN can be implemented using any suitable configuration in the CNN technology area.

With reference again to FIG. 2, the pre-processor 206 in various examples performs pre-processing on the multimodal input data 204 to produce spatial and temporal embeddings 208. The spatial and temporal embeddings 208 define dependencies across the different data types of the multimodal input data 204 that allows for fusion of the multimodal input data 204 by aligning the multimodal input data 204 to have the same dimension or scale. In some examples, the dimension or scale defined by the spatial and temporal embeddings 208 is in a smaller domain that allows for the use of sparser data (e.g., sparse sensor measurements, sparse image data, etc.).

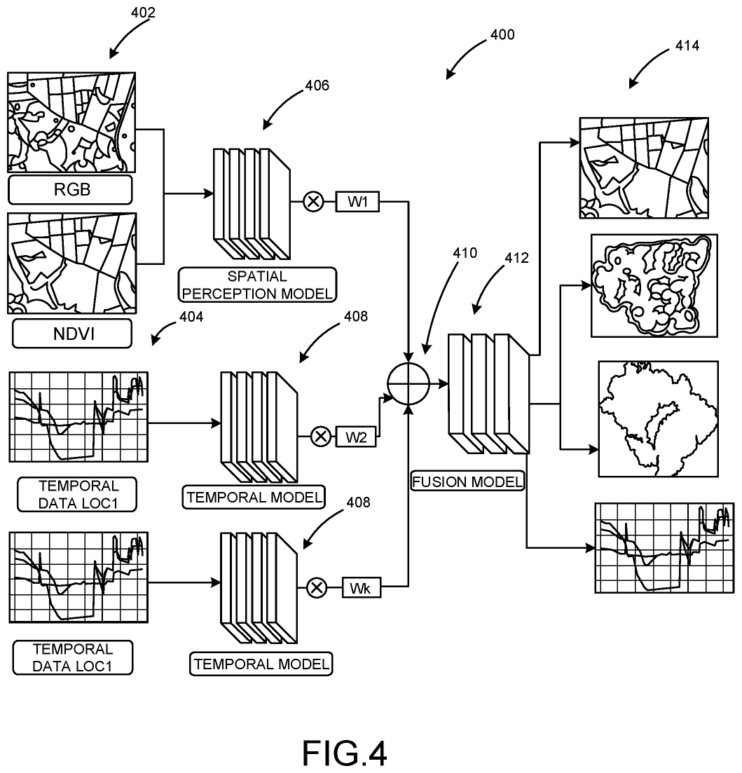

The asynchronous fusion computation processor 202 performs fusion 210 to generate the output 212. That is, the fusion 210 is used to fuse or otherwise combine the spatial and temporal embeddings 208. For example, a fusion architecture 400 configured to perform the fusion 210 is illustrated in FIG. 4. The fusion architecture 400 performs asynchronous fusion using the spatial and temporal embeddings 208. In the illustrated example, as can be seen, spatial data 402 and temporal data 404 (which can comprise the multimodal input data 204) are processed through different processing paths, wherein a spatial perception model 406 (e.g., a CNN) is used for the spatial data 402 to produce a spatial embedding (e.g., RGB image data and Normalized Difference Vegetation Index (NVDI) image data) and temporal models 408 (e.g., a long short-term memory (LSTM) recurrent neural network (RNN) or a one-dimensional CNN) are used for the temporal data (e.g., temporal measurement data from sensors at different geographic locations that are sparsely positioned) to produce timeseries embeddings. It should be noted that although a single spatial perception model 406 is shown and multiple temporal models 408 are shown, additional spatial perception models 406 or fewer or additional temporal models 408 can be used.

In the fusion architecture 400, the spatial perception model 406 and multiple temporal models 408 produce embeddings (e.g., the spatial and temporal embeddings 208), wherein the embedding for each modality is multiplied by a weight (W1, W2, . . . , Wₖ). In some examples, the weights are learned as part of an optimization process as described in more detail herein. The weighted embeddings, that is, the embeddings output from the spatial perception model 406 and multiple temporal models 408 are weighted and then summed together by a summer at 410. In one example, the summed weighted embeddings are considered fused embeddings and input to a fusion model. That is, in the illustrated example, the weighted embeddings are summed and input to the fusion model 412, which obtains a desired target variable (e.g., fuses the spatial and temporal embeddings with an “attention” mechanism to estimate the desired target variable, wherein the desired target variable can be spatial in nature such as images, heatmaps, or boundary maps or temporal in nature such as time series). For example, the fusion model 412 captures the dependencies between the multimodal input data 204 (e.g., spatial (image) and temporal datasets defined by the spatial data 402 and temporal data 404) and generates as an output 414, such as one or more signals of interest. In one example, the signals of interest are generated by running the fused embeddings through layers of a neural network defined by the fusion model 412.

It should be noted that other fusion architectures are contemplated by the present disclosure. For example, instead of an “early” fusion as illustrated by the fusion architecture 400, a “late” fusion can be performed wherein the embeddings are first processed and then high-level features are extracted, which are then fused together. It should be noted that in these implementation, the attention mechanism is a simple weighted addition, but as should be appreciated, the complexity can be increased, such as if more data is available. Thus, the fusion model 412 fuses the spatial and temporal embeddings 208 with some type of attention mechanism to estimate the desired target variable.

With reference again to FIG. 2, the asynchronous fusion computation processor 202 has details of the neural network topology (such as the number of layers, the types of layers, how the layers are connected, the number of nodes in each layer, the type of neural network), the input parameters, etc., which can be specified by an operator. For example, an operator is able to specify the neural network topology using a graphical user interface 216. When the neural network is trained, a signal of interest can be efficiently obtained from multimodal spatio-temporal data.

Once the operator has configured one or more parameters, such as a desired signal of interest, the asynchronous fusion computation processor 202 is configured to perform fusion of multimodal data to obtain desired outputs (e.g., estimated or predicted output values). It should be noted that in examples where fusion network training is performed, once the training is complete (for example, after the training data is exhausted) a trained fusion network 218 is stored and loaded to one or more end user devices such as the smart phone 208, the wearable augmented reality computing device 212, the laptop computer 210 or other end user computing device. The end user computing device is able to use the trained fusion network 218 to carry out the task for which the neural network has been trained.

When the present disclosure is applied, for example, to a DNN, in one example, a signal of interest can be obtained using determined dependencies across the multimodal data as discussed herein.

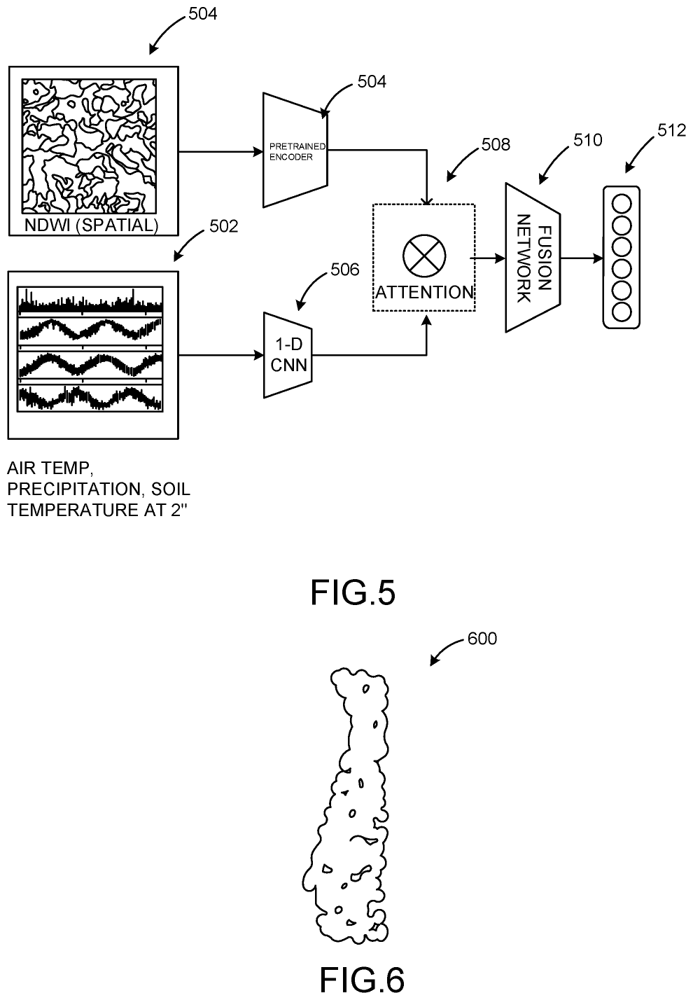

Thus, the present disclosure allows for performing fusion operations where there is no corresponding data in all modalities at the same time, for example, as illustrated in FIGS. 5 and 6. As described in more detail herein, before starting the training process, various examples align the corresponding time series data 502 to spatial data 504. In the illustrated example, the time series data 502 and spatial data 504 comprise satellite images taken for a farm every day, but sensor data collected every one hour. As such, twenty-four hours of temporal data is to be aligned with each spatial data. As should be appreciated, this alignment is data and application dependent. Using fusion processes described herein, applications such as this, having less data, can still result in training deep learning networks to have accurate results, unlike conventional approaches wherein less data and more parameters results in overfitting and less accurate results.

The example of FIGS. 5 and 6 illustrates estimation of values where no measurements are available for certain areas. That is, for this task, the goal is to estimate soil temperature at a different depth than where the sensors are deployed. As should be appreciated, different estimations can be made, such as for soil moisture, wildfire boundary prediction, etc. With various examples, a pretrained encoder 504 processes the spatial data 504 and a one-dimensional CNN 506 processes the series data 502, which are combined with a combiner 508 that includes an attention mechanism to thereafter be fused by a fusion network 510 to generate an output 512 (e.g., soil temperature at a depth not having a sensor).

For this soil temperature example, consider having a sensor at 2 inches in the farm. Values are then desired of a particular variable at 4 inches, 6 inches, 8 inches, etc. With the present disclosure, the cumbersome and costly process of deploying sensors at these different depths is reduced or eliminated. That is, the desired values are estimated, which reduces the time and cost for installing additional sensors.

In the present example, the task is to estimate values at the same location, but at different depths where no sensors are deployed. As should be appreciated, as one temporal modality is not enough to perform the estimation, another modality in the form of spatial data is used. In this example, the spatial data used is a water index computed from satellite images. Thus, in this example, asynchronous fusion is used to estimate values where there are no measurements available (instead of where spares measurements are available). That is, the goal is to estimate soil temperature at a different depth than where sensors are deployed, and with the present disclosure, the asynchronous fusion is used to recover non-measurable missing data points (e.g., interpolate soil moisture data) by leveraging other inputs, such that a soil temperature heatmap 600 with more complete data is generated. For example, estimated temperatures at different depths having no sensors are accurately estimated.

In one particular example for estimating soil temperature at different depths, aggregate data (e.g., from the AgWeatherNet project from Washington State University having a network of data collection facilities across many farms Washington State that maintains and frequently update a large repository of regularly collected data from the farms) relates to measured soil temperature. For example, in some farms, soil temperature is measured at two different depths at 8 inches and 2 inches, with a sampling period of one hour. In one example, the soil temperature at 8 inches is estimated given only the soil temperature at 2 inches and compared to the measured temperature at 8 inches. However, as soil temperature at 2 inches is only a weak predictor of the soil temperature at 8 inches, the present disclosure utilizes additional available information in the form of a normalized difference water index (NDWI) computed through satellite images with a sampling period of twenty hours, and other temporal data collected at the farm, such as air temperature, soil moisture etc.

In one example, a three-layer encoder of a convolutional auto-encoder is trained and used to produce the spatial embeddings in R¹⁰⁰. Random flips and random crops are used as the primary spatial augmentation scheme. Temporal embeddings are produced through a one-dimensional convolutional encoder as described herein, using a sliding window approach to enable augmentation. The embeddings are fused through a three-layer MLP with rectifier linear (ReLu) activation function, with weighted attention as the attention mechanism. The task specific network θₜ is trained with an objective to minimize the sum of L1 and L2 norms of the difference between predicted and ground-truth values. An Adam optimizer with a learning rate of 1 e-4 is used to train all the networks in one example.

With the above-discussed approach, the performance of the herein described asynchronous fusion for estimating values of soil temperature at eight inches was measured through a Mean Absolute Percentage Error (MAPE). It was determined that the asynchronous fusion delivered a performance of 96.04% MAPE. As such, soil temperature sensors deployed at depths other than two inches do not need to be deployed when implementing the present disclosure, which is infeasible in some instances due to space and price limitations.

It should be appreciated that other applications are contemplated, for example, to produce heatmaps (e.g., soil moisture heatmaps) by computing values at the same depth level, but at different locations by using spare sensor data. For example, the present disclosure is implementable to estimate soil moisture heatmaps with desired values across the farm, which can be used to achieve sustainable and precision farming. The heatmaps guide farmers to take relevant action on the desired locations rather than taking actions uniformly across the farm, thus wasting valuable resources like water, manure, fertilizers etc. However, achieving this by employing a dense sensor placement across the farm is neither economically nor practically feasible. With the present disclosure, heatmaps are produced for a desired output variable, for example soil moisture, across the farm given sparsely deployed sensor values.

In this example, let be S be the number of sensors in the farm deployed according to a sensor placement algorithm. The sensors collect desired target variable values at respective sensor locations with a sampling period Tₛ. In this example, the heatmap generation is an interpolation problem, which is posed by the present disclosure as a regression problem (and validated on available sensors measurements in a leave one out fashion). To enable accurate efficient heatmaps, the regression architecture is conditioned based on the sensor's physical latitude and longitude. This is achieved while training, wherein each sensor's values are appended with the relative latitude and longitude to that of the sensor being validated.

The models of the present disclosure were validated on a farm with S as thirty-five (e.g., there are thirty-five sensors deployed in the farm that measure soil moisture and other parameters such as precipitation, etc.) over a one year period with a sampling period of one hour. Using a 80-20 split, the model is trained. Spatial measurements of the farm are also utilized through remote sensing in the form of NDWI and Normalized Difference Vegetation Index (NDVI). The spatial data is collected with a sampling period of forty-eight hours.

In one implementation, the architecture is configured as described herein. In this example, each sensor is considered as one modality and spatial data as one modality. Thus, there are S+2 modalities. Training is performed on S+1 modalities, while validating on the other modality. However, due to the paucity in data, randomly sampled K sensors from the available thirty-five sensors are used and validated on another sensor not included in the training list. Thus, K θ_{fi}'s are trained. The auto-encoder architecture is kept constant for all sensors. The first layer for all θ_{fi}'s for sensor data is a one-dimensional convolutional layer. With K=20, as NDVI and NDWI are single channel images, the images were concatenated and a three-layer convolutional auto encoder was used to obtain the spatial feature extractor.

Weighted attention on features extracted from θ_{fi}'s is used. The task specific network in this example is an MLP with two fully connected layers that output the estimated validation sensor values and is trained to minimize the means squared error loss. Once the model is trained, sampling is performed uniformly across the farm to generate candidate latitude and longitudes. The trained model is fed with K sensor values along with the respective relative latitude and longitude from the desired candidate location. Thus, with finely sampling the farm's polygon, dense interpolation is performed to generate the heatmap.

In this example, quantitative evaluation was performed through a pearson correlation coefficient computed from the known sensor values in the testing date range and estimated values. The baselines used a comparison from the Krigging method, along with nearest neighbor interpolation. The results indicated that the present disclosure outperformed other methods.

As another example, the present disclosure can be used to predict wildfire boundary maps. In this example, the fire's boundary map for time t+1 is predicted, given spatial data such as digital elevation of an area and a current boundary map, along with temporal data such as air temperature, wind speed, and air moisture. As should be appreciated, this is an asynchronous spatio-temporal problem, wherein asynchronous fusion according to various examples can be performed.

In this example, wildfire boundary maps and digital elevation images for the region are used as spatial data. A total amount of fourteen wildfire data is used with ten utilized in training and four wildfires to validate the approach. Shape files depicting the boundary maps of the fires are re-normalized via corresponding digital elevation files for the boundaries. Measured weather data was used based on latitude and longitude specified in the shape files. The two spatial inputs, boundary maps and digital elevation are concatenated to form a two channel image, which is used to train a spatial convolutional auto-encoder. The encoder outputs spatial embeddings of dimension 100. A one-dimensional convolutional architecture is used to embed the time series data. The spatial and temporal embeddings are fused through a learned weighted attention mechanism to output the boundary map for next time step. The task specific network Otis optimized to minimize the sum of L1 and L2 norms of the predicted and ground truth boundary maps. It was determined that the present disclosure is able to suitably predict wildfire boundaries.

It should be appreciated that modifications and variations are contemplated. For example, different “attention” or attenuation mechanisms can be used. Also, the scope of the target variables can be changed. Additionally, variables in other fields of interest can be estimated.

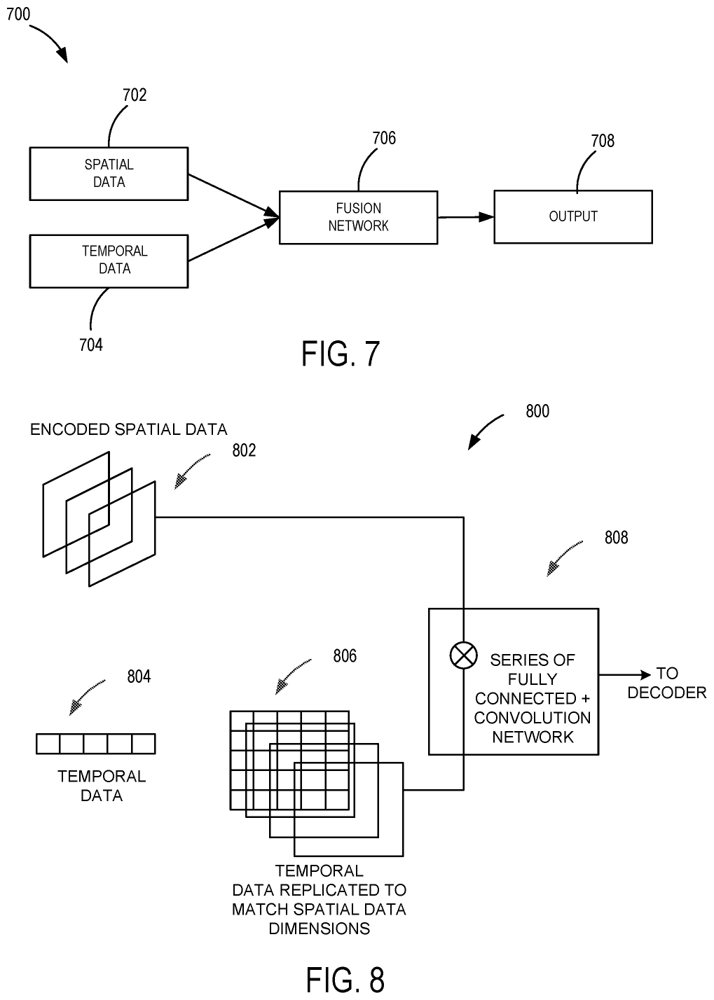

Thus, with various examples, which are implementable in many different applications, spatial data 702 and temporal data 704 are fused by a fusion network 704 in a fusion process 700 to generate an output 708 that otherwise cannot be determined or accurately determined as illustrated in FIG. 7. For example, asynchronous fusion of various examples is configured as a machine learning network to derive intelligence from fragmented spatio-temporal data sources for data which are otherwise not measurable. It should be appreciated that the framework that performs the fusion process 700 as described herein is configured to receive and process different data types (e.g., images, sensor measurements, timeseries data, etc.) in different fields of interest (e.g., agriculture, genomics, logistics, etc.). The present disclosure is implementable in the analysis of different types of multimodal data, and is not limited to spatio-temporal data. That is, the present disclosure provides a general purpose deep learning framework for use in different applications with different types of data.

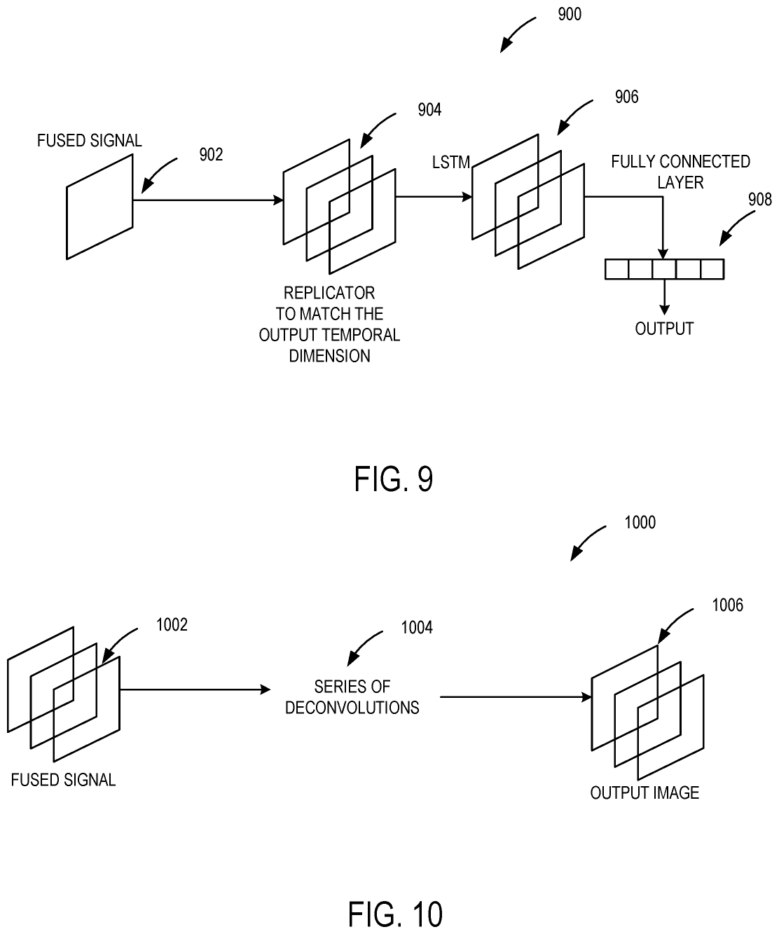

In one example, the fusion process implements a fusion mechanism 800 as illustrated in FIG. 8, a temporal decoder 900 as illustrated in FIG. 9, and a spatial decoder 1000 as illustrated in FIG. 10. The fusion network 706 is configured in this example to perform fusion operations with the fusion mechanism 800, and from the output 708, a desired target variable is obtained. Based on the desired target variable, an estimated or predicted value is generated. That is, the output 708 is “unpacked” to generate the estimated or predicted value.

More particularly, the fusion mechanism 800 receives encoded spatial data 802 and temporal data 804 with the temporal data replicated at 806 to match the dimension of the spatial data. That is, this replication makes the scale of the encoded image similar to or the same as the temporal data as described in more detail herein. As such, encoded spatial data 802 having embeddings matching a scale of the embeddings of the temporal data 804 can then be processed by multiple layers of a neural network.

In one example, the fusion mechanism 800 learns the correlation for each encoded feature of the spatial modality with the encodings from the temporal signal. This learning is performed by replicating the temporal encoding to the same dimensions as the output feature encoding of the spatial image, and then at 808 feeding the matched scale (or dimensionally matched) data into a series of fully connected layers, which is then fed into a series of convolutional layers to learn any neighborhood correlations. For example, the matched data is fused or combined using a neural network to learn correlations corresponding to one or more subsets of the data.

The combined data is output to the temporal decoder 900 illustrated in FIG. 9 or the spatial decoder 1000 as illustrated in FIG. 1. In the illustrated example, the fused data is input to the temporal decoder 900 or the spatial decoder 1000, as a fused signal 902 or a fused signal 1002, respectively. In one example, the temporal decoder 900 or the spatial decoder 1000 unpacks the fused data (e.g., fused spatio-temporal data) to estimate the target variable. As should be appreciated, there are different types of variables that can be estimated with implementations of the present disclosure.

In one example, a univariate temporal signal is estimated, such as a single temporal point or a sequence of temporal points. In this example, the temporal decoder 900 is used. As can be seen, the temporal decoder 900 includes a replicator 904 configured to match the output temporal dimension. That is, the replicator 904 is configured as a replicator of the fused signal to match the temporal dimension of the output signal from the fusion mechanism 800. In this example, the output of the replicator is fed into an LSTM neural network 906 with context vectors that is configured to capture dependencies across the temporal dimension. The LSTM neural network in one example is an LSTM RNN as described herein. The processing is performed using a fully connected layer 908 for each temporal dimension to generate an output. As such, a desired target variable is obtained from the output, which is then used to generate the estimated value corresponding to the single point or sequence of temporal points.

In another example, spatial data or image data is estimated, such as estimating RGB images or a sequence of geographic JavaScript Objection Notation (geoJSON) coordinates on a two-dimensional (2D) plane. In this example, the spatial decoder 1000 is used. As can be seen, the spatial decoder 1000 is configured to receive the fused signal 1002 and process the fused signal 1002 using a series of deconvolutions 1004 to generate an output image 1006. That is, the spatial decoder 1000 is configured as a decoder mechanism having a series of transposed convolutional layers/deconvolutional networks that deconvolve the images of fused signal 1002 into output images 1006 that represent an estimate of RGB images or coordinates. As should be appreciated, the fusion mechanism 800 in combination with the temporal decoder 900 or the spatial decoder 1000 can be used in different applications and to perform estimates with respect to different spatio-temporal data.

Thus, the inputs are spatial and temporal in nature and the outputs are either a spatial image, a temporal signal or classification logits, in some examples. The present disclosure is agnostic to the architecture of each “module” or stage and the kinds of outputs. As such, a generic framework is provided that admits different kinds of architecture and output types to solve machine learning problems posed either as classification or regression tasks.

The present disclosure allows for analysis of or reasoning from multiple modes of information efficiently, for example, for reliable decision making in critical systems. In addition to the examples described herein, the present disclosure is implementable in applications such as self-driving cars, wherein an autonomous agent has to reason from inputs such as RGB camera, Lidar, GPS, etc. The present disclosure allows for spatio-temporal learning (multimodal learning) using large spatio-temporal datasets such as maps, virtual globes, remote-sensing images, along with perception and reasoning from neural network architectures, including CNNs and RNNs. With the present disclosure, the assumption that the sampling frequencies of all modes of data available are the same (e.g., at any given point) is not used or needed.

With the asynchronous fusion of various examples, desired outputs are produced that can leverage computer vision and natural language processing achieved via pre-training. The asynchronous fusion that uses auto-encoders to derive pre-trained feature representations due to the lower complexity and lesser data requirements as compared to that of advanced models such as transformers, allows for a task-specific network to be more accurately trained with the feature representations from pre-trained networks fused with learned attention mechanisms.

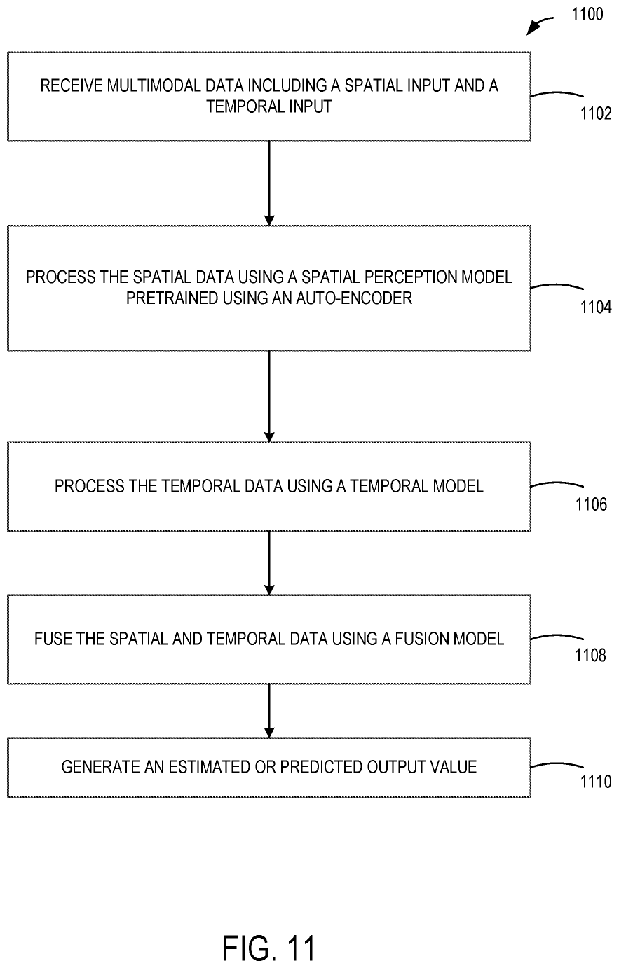

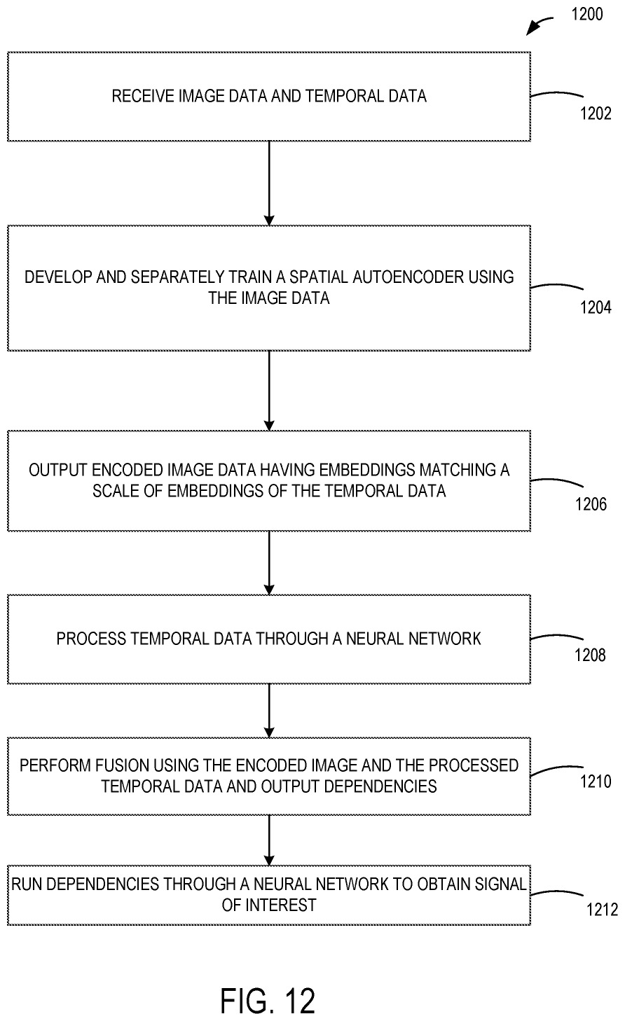

As should be appreciated, the various examples can be used in the operation of different types of neural networks. Additionally, the various examples can be used to perform fusions of different types of multimodal data. FIGS. 11 and 12 illustrate flow charts of methods 1100 and 1200 for performing various aspects of data fusion of various examples. The operations illustrated in the flow charts described herein can be performed in a different order than is shown, can include additional or fewer steps and can be modified as desired or needed. Additionally, one or more operations can be performed simultaneously, concurrently, or sequentially. The methods 1100 and 1200 are performed in some examples on computing devices, such as a server or computer having processing capabilities to efficiently perform the operations, such as a graphics processing unit (GPU).

With reference to the method 1100, illustrating a method for fusion of multimodal data, a computing device receives a spatial input and a temporal input at 1102. In one example, the spatial input comprises spatial data having spatial embeddings and the temporal input comprises temporal data having temporal embeddings. As described herein, this multimodal data includes the spatial embeddings and the temporal embeddings having different time dimensions.

The computing device processes the spatial data using a spatial perception model at 1104 to generate a spatial data output with the spatial embeddings having a same time dimension as the temporal embeddings. That is, the spatial data in some examples is processed by a pretrained auto-encoder (e.g., a separately trained encoder) comprising a convolutional neural network that allows for aligning the mode of the spatial data with the mode of the temporal data.

The processing device also processes the temporal data using a temporal model at 1106 to generate a temporal data output. The spatial data output and the temporal data output are combined to generate combined embeddings that captures dependencies between the different modes as described herein, which in one example, includes weighting the embeddings of each of the spatial data output and temporal data output as described herein and summing the weighted embeddings.

The processing device then fuses the spatial data output and the temporal data output using a fusion model at 1108 into an output (representing dependencies between the spatial input and the temporal input) to obtain a desired target variable having a correlation with the spatial input and the temporal input. In one example, the fusion model using dependencies (e.g., the captured dependencies described above) between the spatial input and the temporal input to obtain the desired target variable. In some examples, the target variable represents one or more signals of interest. The computing device uses the target variable to generate an estimated or predicted output value at 1110. For example, the estimated or predicted output value in some examples is a value corresponding to sparse sensor measurements, areas where no measurement sensors are present, etc.

Thus, the method 1100 in some examples performs asynchronous fusion that includes (i) pretraining, (ii) fusion with attention, and (iii) training a task specific network. In some examples, the asynchronous fusion is agnostic to the number of modes. Thus, to generalize, each mode Mᵢ has a sampling period of Tᵢ. The two modes Mᵢ and Mⱼ need not have the same sampling periods. Let the data samples in each mode be represented by Xᵢ and the required target variable Y have a sampling period of max T₁, . . . T_{M}. Using the models described herein, which are configured as a feature extractor in some examples, for each mode the feature extractor is parameterized by a neural network with parameters θ_{fi}. The task specific network is parameterized by another neural network with parameters θₜ.

With the above-described generalization, the pre-training phase in some examples involves training of a convolutional auto-encoder for each of the modes, which in various examples is a convolutional autoencoder, but other encoders, such as LSTMs can be used. Asynchronous fusion is performed using CNN based auto-encoders for spatial, as well as temporal data streams. However, it should be noted that the asynchronous fusion is agnostic to the nature of the network used for pre-training. The autoencoder, such as the autoencoder 300 is a combination of two networks as described herein: (i) an encoder and (ii) a decoder. The encoder with a lower bottleneck dimension, encodes data to provide a low-dimensional representation, while the decoder attempts to reconstruct the data back. In one example, the autoencoder 300 is trained to minimize the mean square reconstruction cost. Once trained, the decoder is discarded and the encoder is used as the pre-trained feature extractor θ_{fi}, which produces features Uᵢ for data Xᵢ.

With respect to fusion, the fusion of the features Uᵢ for each mode Mᵢ is performed in some examples using a simple attention mechanism, such as a dot-product operator, transformers, or weighted addition mechanisms, among others. As described herein, one example uses a weighted addition mechanism, which is due in part to the simplicity and use of fewer parameters of this implementation as compared to other methods. This mechanism leads to a fused representation Z=wᵢ*Uᵢ, where wᵢ, the scalar weights, are learned as a part of the optimization.

The task specific network, which in one example is a classifier, or in another example is a regressor, is then trained on Z, Y pairs to minimize an appropriate loss function. Thus, for example, different geo-spatial spatio-temporal problems can be solved by fusing data as described herein.

With reference to the method 1200, illustrating a method for fusion of multimodal data to obtain a signal of interest, a computing device receives image data and temporal data at 1202. The image data and the temporal data (e.g., sensor data) are sampled at different frequencies (e.g., spatial data sampled once per day and temporal data sampled once every fifteen minutes).

The computing device develops and separately trains a spatial autoencoder using only the image data at 1204. For example, before processing the image data, a spatial autoencoder is separately configured using the image data and then trained. The output in various examples is an encoded image (e.g., rather than an RGB image, the encoded image is more informative and dense about the underlying image, but is smaller in overall size—decreased in size). As described in more detail herein, in some examples, the result is the embeddings (e.g., encoded image) as the output. As such, this makes the scale of the encoded image similar to or the same as the temporal data. That is, the computing device outputs encoded image data at 1206 having embedding matching a scale of the embeddings of the temporal data.

The computing device process the temporal data through a neural network at 1208. That is, as described herein, the temporal data is processed to determine corresponding embeddings. For example, the temporal data is taken “as-is” (e.g., also referred to as non-encoded or not encoded, because this data is already in a smaller dimension) and passed through a series of NN layers that output corresponding embeddings.

The computing device performs fusion at 1210. In one example, the fusion is performed using the encoded image and the processed temporal data to output dependencies. That is, the fusion captures the dependencies between the encoded image and processed temporal data that have embeddings of a matched scale. For example, the dependencies among the data (e.g., soil humidity and soil moisture) are captured. As should be appreciated, the dependencies are captured over time and across different signal types as described herein. The output in some examples, is thus, the dependencies between the two inputs.

The dependencies are run through a neural network at 1212 to obtain a signal of interest. For example, as described herein, the signal of interest can relate to one or more estimated or predicted values.

Thus, in some examples, the method 1100 or method 1200 can be used to perform multimodal data fusion to obtain a signal of interest.

### Exemplary Operating Environment

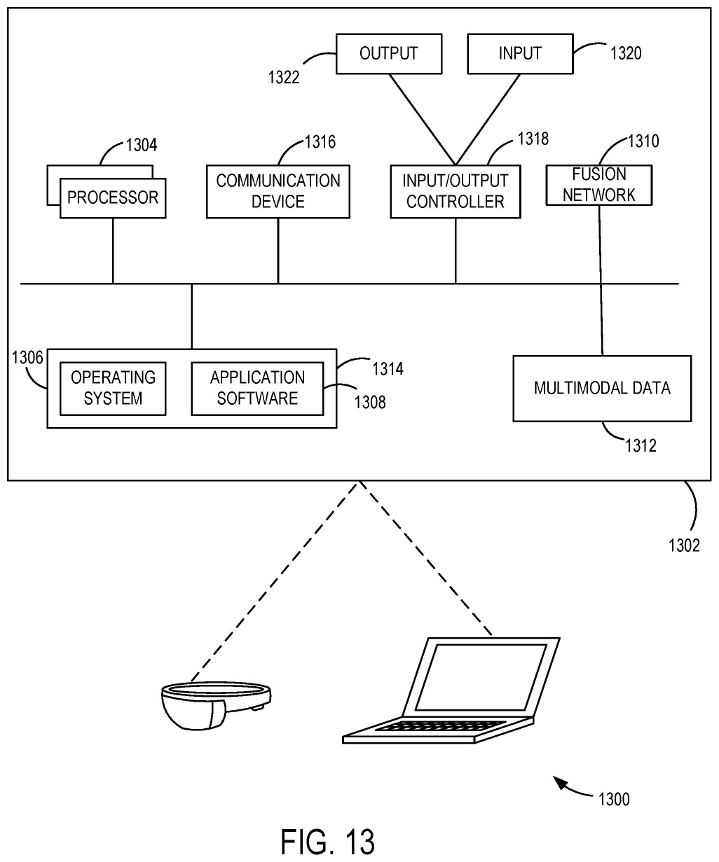

The present disclosure is operable with a computing apparatus 1302 according to an example as a functional block diagram 1300 in FIG. 13. In one example, components of the computing apparatus 1302 may be implemented as a part of an electronic device according to one or more embodiments described in this specification. The computing apparatus 1302 comprises one or more processors 1304 which may be microprocessors, controllers, or any other suitable type of processors for processing computer executable instructions to control the operation of the electronic device. Platform software comprising an operating system 1306 or any other suitable platform software may be provided on the apparatus 1302 to enable application software 1308 to be executed on the device. According to an embodiment, a fusion network 1310 that operates using multimodal data 1312 can be accomplished by software.

Computer executable instructions may be provided using any computer-readable media that are accessible by the computing apparatus 1302. Computer-readable media may include, for example, computer storage media such as a memory 1314 and communications media. Computer storage media, such as the memory 1314, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1314) is shown within the computing apparatus 1302, it will be appreciated by a person skilled in the art, that the storage may be distributed or located remotely and accessed via a network or other communication link (e.g. using a communication interface 1316).

The computing apparatus 1302 may comprise an input/output controller 1318 configured to output information to one or more input devices 1320 and output devices 1322, for example a display or a speaker, which may be separate from or integral to the electronic device. The input/output controller 1318 may also be configured to receive and process an input from the one or more input devices 1320, for example, a keyboard, a microphone, or a touchpad. In one embodiment, the output device 1322 may also act as the input device 1320. An example of such a device may be a touch sensitive display. The input/output controller 1018 may also output data to devices other than the output device 1322, e.g. a locally connected printing device. In some embodiments, a user may provide input to the input device(s) 1020 and/or receive output from the output device(s) 1322.

In some examples, the computing apparatus 1302 detects voice input, user gestures or other user actions and provides a natural user interface (NUI). This user input may be used to author electronic ink, view content, select ink controls, play videos with electronic ink overlays and for other purposes. The input/output controller 1318 outputs data to devices other than a display device in some examples, e.g. a locally connected printing device.

The functionality described herein can be performed, at least in part, by one or more hardware logic components. According to an embodiment, the computing apparatus 1302 is configured by the program code when executed by the processor(s) 1304 to execute the examples and implementation of the operations and functionality described. Alternatively, or in addition, the functionality described herein can be performed, at least in part, by one or more hardware logic components. For example, and without limitation, illustrative types of hardware logic components that can be used include FPGAs, ASICs, ASSPs, SOCs, CPLDs, and GPUs.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Other examples include:

A system for fusion of multimodal data, the system comprising:
at least one processor; and
at least one memory comprising computer program code, the at least one memory and the computer program code configured to, with the at least one processor, cause the at least one processor to:
receive a spatial input and a temporal input, wherein the spatial input comprises spatial data having spatial embeddings and the temporal input comprises temporal data having temporal embeddings, the spatial embeddings and the temporal embeddings having different time dimensions;
generate, from the spatial data based on a spatial perception model, a spatial data output with the spatial embeddings having a same time dimension as the temporal embeddings, the spatial perception model being pre-trained with an autoencoder comprising a neural network;
generate, from the temporal data based on a temporal model, a temporal data output;
combine, using a fusion model, the spatial data output and the temporal data output into an output representing dependencies between the spatial input and the temporal input;
obtain, from the output, a desired target variable; and
generate, based on the desired target variable, one of an estimated or predicted value.

Other examples include:

A computerized method for fusion of multimodal data, the computerized method comprising:
receiving a spatial input and a temporal input, wherein the spatial input comprises spatial data having spatial embeddings and the temporal input comprises temporal data having temporal embeddings, the spatial embeddings and the temporal embeddings having different time dimensions;
generating, from the spatial data based on a spatial perception model, a spatial data output with the spatial embeddings having a same time dimension as the temporal embeddings, the spatial perception model being pre-trained with an autoencoder comprising a neural network;
generating, from the temporal data based on a temporal model, a temporal data output;
combining, using a fusion model, the spatial data output and the temporal data output into an output representing dependencies between the spatial input and the temporal input;
obtaining, from the output, a desired target variable; and
generating, based on the desired target variable, one of an estimated or predicted value.

Other examples include:

One or more computer storage media having computer-executable instructions for fusion of multimodal data that, upon execution by a processor, cause the processor to at least:
receive a spatial input and a temporal input, wherein the spatial input comprises spatial data having spatial embeddings and the temporal input comprises temporal data having temporal embeddings, the spatial embeddings and the temporal embeddings having different time dimensions;
generate, from the spatial data based on a spatial perception model, a spatial data output with the spatial embeddings having a same time dimension as the temporal embeddings, the spatial perception model being pre-trained with an autoencoder comprising a neural network;
generate, from the temporal data based on a temporal model, a temporal data output;
combine, using a fusion model, the spatial data output and the temporal data output into an output representing dependencies between the spatial input and the temporal input;
obtain, from the output, a desired target variable; and
generate, based on the desired target variable, one of an estimated or predicted value.

Alternatively, or in addition to the examples described above, examples include any combination of the following:
summing the weighted spatial data output and the weighted temporal output before fusing the spatial data output and the temporal data output.
wherein the spatial data comprises image data and the temporal data comprises sensor data from a plurality of sensors, and further comprising outputting an encoded image as the spatial data output, the encoded image having additional image information and a smaller overall size.
wherein the temporal data is non-encoded data.
using the desired target variable to generate one of the estimated or predicted output value for a location not having any of the plurality of sensors.
wherein the fusion model comprises a multi-layer neural network.
separately pre-training the autoencoder.
wherein the spatial data comprises image data of a farm, the temporal data comprises sensor values from a plurality of sensors in the farm, and the desired target variable is soil moisture, and further comprising generating a heatmap having as estimated values, the soil moisture at locations in the farm without a sensor, wherein the fusion model defines layers of a neural network outputting estimated validation sensor values conditioned on relative latitude and longitude data from the plurality of sensors, and a task specific network is trained to minimize a means squared error loss of the output of the neural network.
wherein the spatial data comprises image data of a farm, the temporal data comprises sensor values from a plurality of sensors in the farm, and the desired target variable is soil temperature, and further comprising generating a heatmap having as estimated values, the soil temperature at depths in the farm without a sensor, wherein a task specific network is trained to minimize a sum of L1 and L2 norms of a difference between predicted values output from the fusion model and the sensor values from the plurality of sensors.
wherein the spatial data comprises image data of an area, the temporal data comprises sensor values from a plurality of sensors in the area, and the desired target variable is a wildfire boundary, and further comprising generating a predicted wildfire boundary map having as estimated values, boundaries of a wildfire, wherein a task specific network is trained to minimize a sum of L1 and L2 norms of a difference between predicted boundaries output from the fusion model and boundaries of a current wildfire boundary map

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for training a neural network. The illustrated one or more processors 1004 together with the computer program code stored in memory 1014 constitute exemplary processing means for fusing multimodal data.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for fusion of multimodal data, the system comprising:
at least one processor; and
at least one memory comprising computer program code, the at least one memory and the computer program code configured to, with the at least one processor, cause the at least one processor to:
receive a spatial input and a temporal input, wherein the spatial input comprises spatial data having spatial embeddings and the temporal input comprises temporal data having temporal embeddings, the spatial embeddings and the temporal embeddings having different time dimensions;
generate, from the spatial data based on a spatial perception model, a spatial data output with the spatial embeddings having a same time dimension as the temporal embeddings, the spatial perception model being pre-trained with an autoencoder comprising a neural network;
generate, from the temporal data based on a temporal model, a temporal data output;
combine, using a fusion model, the spatial data output and the temporal data output into an output representing dependencies between the spatial input and the temporal input;
obtain, from the output, a desired target variable; and
generate, based on the desired target variable, one of an estimated or predicted value.

2. The system of claim 1, wherein the at least one memory and the computer program code are further configured to, with the at least one processor, cause the at least one processor to:
weight the spatial data output and the temporal data output; and
sum the weighted spatial data output and the weighted temporal output before fusing the spatial data output and the temporal data output.

3. The system of claim 1, wherein the spatial data comprises image data and the temporal data comprises sensor data from a plurality of sensors, and the at least one memory and the computer program code are further configured to, with the at least one processor, cause the at least one processor to output an encoded image as the spatial data output, the encoded image having additional image information and a smaller overall size.

4. The system of claim 3, wherein the at least one memory and the computer program code are further configured to, with the at least one processor, cause the at least one processor to use the desired target variable to generate one of the estimated or predicted output value for a location not having any of the plurality of sensors.

5. The system of claim 1, wherein the at least one memory and the computer program code are further configured to, with the at least one processor, cause the at least one processor to separately pre-train the autoencoder.

6. The system of claim 1, wherein the spatial data comprises image data of a farm, the temporal data comprises sensor values from a plurality of sensors in the farm, and the desired target variable is soil moisture, the at least one memory and the computer program code are further configured to, with the at least one processor, cause the at least one processor to generate a heatmap having as estimated values, the soil moisture at locations in the farm without a sensor, wherein the fusion model defines layers of a neural network outputting estimated validation sensor values conditioned on relative latitude and longitude data from the plurality of sensors, and a task specific network is trained to minimize a means squared error loss of the output of the neural network.

7. The system of claim 1, wherein the spatial data comprises image data of a farm, the temporal data comprises sensor values from a plurality of sensors in the farm, and the desired target variable is soil temperature, the at least one memory and the computer program code are further configured to, with the at least one processor, cause the at least one processor to generate a heatmap having as estimated values, the soil temperature at depths in the farm without a sensor, wherein a task specific network is trained to minimize a sum of L1 and L2 norms of a difference between predicted values output from the fusion model and the sensor values from the plurality of sensors.

8. The system of claim 1, wherein the spatial data comprises image data of an area, the temporal data comprises sensor values from a plurality of sensors in the area, and the desired target variable is a wildfire boundary, the at least one memory and the computer program code are further configured to, with the at least one processor, cause the at least one processor to generate a predicted wildfire boundary map having as estimated values, boundaries of a wildfire, wherein a task specific network is trained to minimize a sum of L1 and L2 norms of a difference between predicted boundaries output from the fusion model and boundaries of a current wildfire boundary map.

9. A computerized method for fusion of multimodal data, the computerized method comprising:
receiving a spatial input and a temporal input, wherein the spatial input comprises spatial data having spatial embeddings and the temporal input comprises temporal data having temporal embeddings, the spatial embeddings and the temporal embeddings having different time dimensions;
generating, from the spatial data based on a spatial perception model, a spatial data output with the spatial embeddings having a same time dimension as the temporal embeddings, the spatial perception model being pre-trained with an autoencoder comprising a neural network;
generating, from the temporal data based on a temporal model, a temporal data output;
combining, using a fusion model, the spatial data output and the temporal data output into an output representing dependencies between the spatial input and the temporal input;
obtaining, from the output, a desired target variable; and
generating, based on the desired target variable, one of an estimated or predicted value.

10. The computerized method of claim 9, further comprising:
weighting the spatial data output and the temporal data output; and
summing the weighted spatial data output and the weighted temporal output before fusing the spatial data output and the temporal data output.

11. The computerized method of claim 9, wherein the spatial data comprises image data and the temporal data comprises non-encoded sensor data from a plurality of sensors, and further comprising outputting an encoded image as the spatial data output, the encoded image having additional image information and a smaller overall size.

12. The computerized method of claim 11, further comprising using the desired target variable to generate one of the estimated or predicted output value for a location not having any of the plurality of sensors.

13. The computerized method of claim 9, wherein the fusion model comprises a multi-layer neural network.

14. The computerized method of claim 9, further comprising separately pre-training the autoencoder.

15. One or more computer storage media having computer-executable instructions for fusion of multimodal data that, upon execution by a processor, cause the processor to at least:
receive a spatial input and a temporal input, wherein the spatial input comprises spatial data having spatial embeddings and the temporal input comprises temporal data having temporal embeddings, the spatial embeddings and the temporal embeddings having different time dimensions;
generate, from the spatial data based on a spatial perception model, a spatial data output with the spatial embeddings having a same time dimension as the temporal embeddings, the spatial perception model being pre-trained with an autoencoder comprising a neural network;
generate, from the temporal data based on a temporal model, a temporal data output;
combine, using a fusion model, the spatial data output and the temporal data output into an output representing dependencies between the spatial input and the temporal input;
obtain, from the output, a desired target variable; and
generate, based on the desired target variable, one of an estimated or predicted value.

16. The one or more computer storage media of claim 15, having further computer-executable instructions that, upon execution by a processor, cause the processor to at least:
weight the spatial data output and the temporal data output; and
sum the weighted spatial data output and the weighted temporal output before fusing the spatial data output and the temporal data output.

17. The one or more computer storage media of claim 15, wherein the spatial data comprises image data and the temporal data comprises sensor data from a plurality of sensors, and having further computer-executable instructions that, upon execution by a processor, cause the processor to at least to output an encoded image as the spatial data output, the encoded image having additional image information and a smaller overall size.

18. The one or more computer storage media of claim 17, wherein the temporal data is non-encoded data.

19. The one or more computer storage media of claim 17, having further computer-executable instructions that, upon execution by a processor, cause the processor to at least use the desired target variable to generate one of an estimated or predicted output value for a location not having any of the plurality of sensors.

20. The one or more computer storage media of claim 15, wherein the fusion model comprises a multi-layer neural network.
